(19) United States
(12) Patent Application Publication
(10) Pub. No.: US 2025/0150228 A1
(43) Pub. Date: May 8, 2025

(54) POSITIONING REFERENCE SIGNAL CONFIGURATION ENHANCEMENT

(71) Applicant: Telefonaktiebolaget LM Ericsson (publ), Stockholm (SE)

(72) Inventors: Zhilan XIONG, Solna (SE); Ritesh SHREEVASTAV, Upplands Väsby (SE); Mohammed Yazid LYAZIDI, London (GB); Florent MUNIER, Västra Frölunda (SE)

(73) Assignee: Telefonaktiebolaget LM Ericsson (publ), Stockholm (SE)

(21) Appl. No.: 18/911,569

(22) Filed: Oct. 10, 2024

Related U.S. Application Data
(60) Provisional application No. 63/547,172, filed on Nov. 3, 2023.

(51) Int. Cl. H04L 5/00; H04W 72/51

(52) U.S. Cl. CPC H04L 5/0048; H04L 5/0035; H04W 72/51

(57) ABSTRACT

A method performed by a first network node. The method includes, receiving, from a second network node, a configuration request message for on-demand positioning reference signal (PRS) configuration with at least a first transmission and reception point (TRP) associated with the first network node, wherein the configuration request message comprises an extended PRS repetition factor value for the first TRP. The method also includes, after receiving the request message, transmitting to the second network node a response message responsive to the request message, indicating that on-demand PRS configuration is configured or updated with at least the first TRP

### CROSS-REFERENCE TO RELATED APPLICATION(S)

This application claims the benefit of U.S. provisional patent application No. 63/547,172, filed on 2023 Nov. 3, which is incorporated by this reference.

### TECHNICAL FIELD

This disclosure relates to methods and systems for providing positioning reference signal (PRS) configuration enhancement.

### BACKGROUND

The 3rd Generation Partnership Project (3GPP) is discussing New Radio (NR) positioning Release 18 (Rel-18) with potential enhancements for reduced capability (RedCap) positioning in which the maximal bandwidth of a RedCap UE is 20 MHz in frequency range (FR) 1 and 100 MHz in FR2. The solutions are sounding reference signal (SRS) frequency hopping and PRS frequency hopping for improving the accuracy of RedCap positioning.

In NR positioning protocol A (NRPPA) interface between a location management function (LMF) and a next-generation radio access network (NG-RAN) node, there are transmission and reception point (TRP) information transfer function and PRS information transfer function, as disclosed in 3GPP Technical Specification (TS) 38.455.

TRP information transfer function allows an LMF to obtain TRP related information from an NG-RAN node via TRP information exchange procedure which includes transmission and receipt of TRP Information Request message, TRP Information Response message, and TRP Information Failure message.

The purpose of the TRP information exchange procedure is to allow the LMF to request the NG-RAN node to provide detailed information for TRPs hosted by the NG-RAN node. In this procedure, the TRP information in the TRP Information Response message transmitted from the NG-RAN node to the LMF includes on-demand PRS TRP information.

PRS information transfer function allows the LMF to exchange PRS related information with the NG-RAN node via PRS configuration exchange procedure which includes transmission and receipt of PRS Configuration Request message, PRS Configuration Response message and PRS Configuration Failure message.

The PRS configuration exchange procedure is initiated by the LMF to request the NG-RAN node to configure or update (i.e., turn off) PRS transmission. The procedure involves transmission of the PRS Configuration Request message from the LMF to the NG-RAN node, transmission of the PRS Configuration Response message from the NG-RAN node to the LMF, and transmission of the PRS Configuration Failure message from the NG-RAN node to the LMF.

### SUMMARY

Certain challenges presently exist. For example, the PRS configuration in the existing interface between an LMF and an NG-RAN node is initially designed for normal NR UEs. However, a resource repetition factor in the existing PRS configuration may not be long enough for some RedCap UEs because, as compared to normal NR UEs, some RedCap UEs may need a longer resource repetition factor for PRS transmission to support PRS frequency hopping. Therefore, there is a need to enhance the existing PRS configuration.

Accordingly, in on aspect there is provided a method performed by a first network node. The method includes, receiving, from a second network node, a configuration request message for on-demand positioning reference signal (PRS) configuration with at least a first transmission and reception point (TRP) associated with the first network node, wherein the configuration request message comprises an extended PRS repetition factor value for the first TRP. The method also includes, after receiving the request message, transmitting to the second network node a response message responsive to the request message, indicating that on-demand PRS configuration is configured or updated with at least the first TRP.

In another embodiment, the method performed by the first network node includes transmitting to a second network node a configuration request message for on-demand positioning reference signal (PRS) configuration with at least a first transmission and reception point (TRP) associated with the first network node, wherein the configuration request message comprises an extended PRS repetition factor value for the first TRP. The method also includes, after transmitting the configuration request message, receiving from the second network node a response message responsive to the request message, indicating that on-demand PRS configuration is configured or updated with at least the first TRP.

In another embodiment, the method performed by the first network node includes receiving, from a second NN, a request to provide information about one or more transmission and reception points, TRPs, associated with the first NN. The method further comprises, based at least on receiving the request, transmitting, to the second NN, a response message including information about a TRP. The information about the TRP indicates: whether usage of an extended range of a positioning reference signal, PRS, repetition factor value is allowed for the TRP, and/or one or more extended PRS repetition factor values.

In another aspect, there is provided a method performed by a first NN. The method comprises transmitting, to a second NN, a request to provide information about one or more transmission and reception points, TRPs, associated with the second NN. The method further comprises, based at least on transmitting the request, receiving, from the second NN, a response message including information about a TRP. The information about the TRP indicates: whether usage of an extended range of a positioning reference signal, PRS, repetition factor value is allowed for the TRP, and/or one or more extended PRS repetition factor values.

In a different aspect, there is provided a method comprising: obtaining UE type information which indicates a type of a user equipment, UE; and determining that the UE is configured to and/or need to perform a positioning task which requires a positioning update at a certain frequency, wherein the certain frequency satisfies a condition. The method further comprises, based on the determination, updating the type of the UE indicated by the UE type information; and transmitting, to a first NN, updated UE type information which indicates the updated type of the UE.

In a different aspect, there is provided a computer program comprising instructions which when executed by processing circuitry cause the processing circuitry to perform the method of any one of the above embodiments.

In a different aspect, there is provided a carrier containing the computer program of the above embodiment, wherein the carrier is one of an electronic signal, an optical signal, a radio signal, and a computer readable storage medium.

In a different aspect, there is provided a first NN. The first NN is configured to receive, from a second NN, a request to provide information about one or more transmission and reception points, TRPs, associated with the first NN. The first NN is further configured to, based at least on receiving the request, transmit, to the second NN, a response message including information about a TRP. The information about the TRP indicates: whether usage of an extended range of a positioning reference signal, PRS, repetition factor value is allowed for the TRP, and/or one or more extended PRS repetition factor values.

In a different aspect, there is provided a first NN. The first NN is configured to transmit, to a second NN, a request to provide information about one or more transmission and reception points, TRPs, associated with the second NN. The first NN is further configured to, based at least on transmitting the request, receive, from the second NN, a response message including information about a TRP. The information about the TRP indicates: whether usage of an extended range of a positioning reference signal, PRS, repetition factor value is allowed for the TRP, and/or one or more extended PRS repetition factor values.

In a different aspect, there is provided an apparatus. The apparatus is configured to obtain UE type information which indicates a type of a user equipment, UE; and determine that the UE is configured to and/or need to perform a positioning task which requires a positioning update at a certain frequency, wherein the certain frequency satisfies a condition. The apparatus is further configured to, based on the determination, update the type of the UE indicated by the UE type information; and transmit, to a first NN, updated UE type information which indicates the updated type of the UE.

In a different aspect, there is provided an apparatus comprising: a processing circuitry; and a memory, said memory containing instructions executable by said processing circuitry, whereby the apparatus is operative to perform the method of any one of the above embodiments.

Some embodiments of this disclosure allow supporting the use of an extended PRS repetition factor in configuring PRS transmission. For example, in some embodiments, PRS TRP information, e.g., transmitted from an NG-RAN node to an LMF, is modified i) to indicate whether usage of an extended range of a PRS repetition factor value is allowed for a TRP hosted by the NG-RAN node, and/or ii) to include one or more extended PRS repetition factor values.

Additionally or alternatively, in some embodiments, PRS configuration information (e.g., included in the PRS Configuration Request) transmitted from an LMF to an NG-RAN node over NRPPA and/or from gNB-distributed unit (gNB-DU) to gNB-centralized unit (gNB-CU) over F1 Application Protocol (F1AP) is modified to support the extended PRS repetition factor. Additionally, some embodiments of this disclosure allow providing a UE type indication to the LMF such that the LMF can determine an appropriate PRS configuration for the NR-RAN node depending on a majority type of UEs hosted by the NG-RAN node. Additionally, some embodiments of this disclosure allow the UE type indication from an LMF to an NG-RAN over NRPPA and/or from gNB-CU to gNB-DU to help NG-RAN and/or gNB-DU for the decision of allowed PRS configurations for the target TRPs of the NG-RAN and/or gNB-DU.

### BRIEF DESCRIPTION OF THE DRAWINGS

The accompanying drawings, which are incorporated herein and form part of the specification, illustrate various embodiments.

FIG. 1 shows an exemplary scenario where some embodiments of this disclosure can be applied.

FIG. 2 shows a process according to some embodiments.

FIG. 3 shows a process according to some embodiments.

FIG. 4A shows a process according to some embodiments.

FIG. 4B shows a process according to some embodiments.

FIG. 5A shows a process according to some embodiments.

FIG. 5B shows a process according to some embodiments.

FIG. 6 shows a process according to some embodiments.

FIG. 7 shows an apparatus according to some embodiments.

FIG. 8 shows an apparatus according to some embodiments.

FIG. 9 shows an apparatus according to some embodiments.

### DETAILED DESCRIPTION

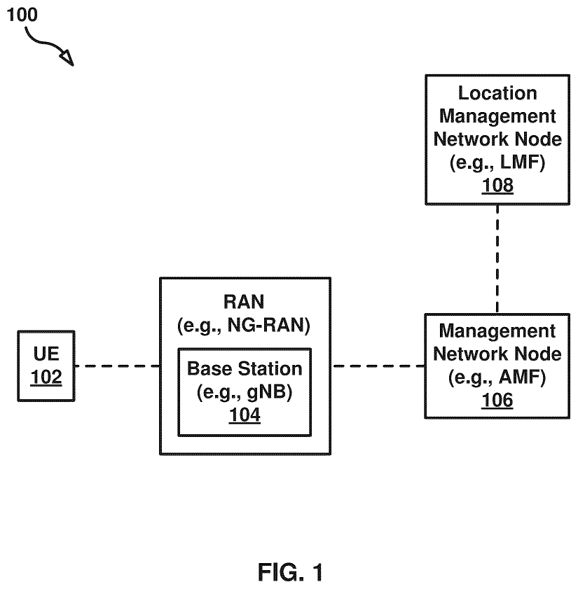

FIG. 1 shows a system 100 according to some embodiments. The system 100 comprises a UE 102, a base station (e.g., gNB—i.e., NG-RAN node) 104, an access management network node (NN) (e.g., access and mobility management function (AMF)) 106, and a location management NN (e.g., location management function (LMF)) 108.

As used herein, a UE is any device capable of transmitting data to and/or receiving data from a base station via a wireless network, and a base station is any device capable of transmitting data to and/or receiving data from a UE via a wireless network. As used herein, an access management NN is an entity capable of managing a UE's access to a wireless network provided by a base station, and a location management NN is an entity capable of managing (e.g., detecting) a location of a UE connected to a wireless network provided by a base station. Here, an entity may be hardware or software. For simple explanation purpose, in the rest of this disclosure, the base station 104 is referred to as “NG-RAN node 104,” the access management NN 106 is referred to as “AMF 106,” and the location management NN 108 is referred to as “LMF 108.”

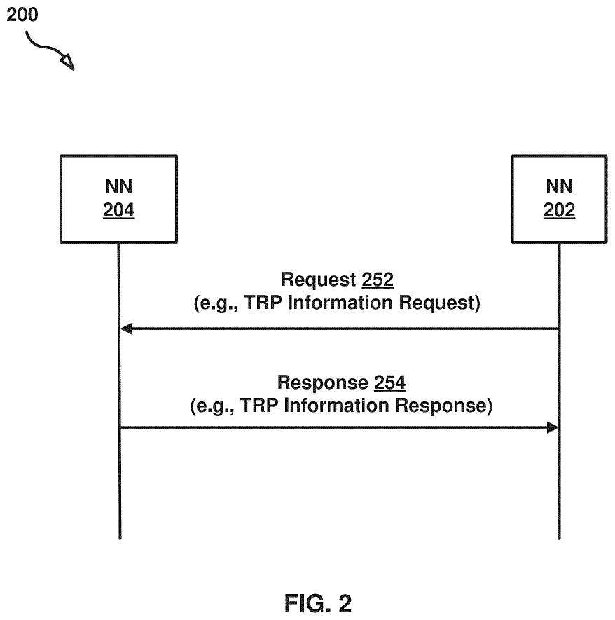

FIG. 2 shows a process 200 for exchanging information about one or more TRPs. The process 200 comprises an NN 202 (e.g., the LMF 108 or an TRP in gNB-DU) transmitting to a NN 204 (e.g., the NG-RAN node 104 or an TRP in gNB-CU) a request 252 (e.g., TRP Information Request) for providing detailed information of TRP(s) hosted by the NG-RAN node 104 or the TRP in gNB-CU. An example of information included in the request 252 is provided below.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.3 | YES | reject |
| NRPPa Transaction | M | | 9.2.4 | — | |
| ID | | | | | |
| TRP List | | 0 . . . 1 | | YES | ignore |
| >TRP Item | | 1 . . . | | EACH | ignore |
| | | <maxnoTRPs> | | | |
| >>TRP ID | M | | 9.2.24 | — | |
| TRP Information | | 1 | | | |
| Type List | | | | | |
| >TRP Information | | 1 . . . | | EACH | reject |
| Type Item | | <maxnoTRPInfoTypes> | | | |
| >>TRP Information | M | | ENUMERATED | | |
| Type Item | | | (nr pci, ng-ran | | |
| | | | cgi, nr arfcn, | | |
| | | | prs config, ssb | | |
| | | | config, sfn init | | |
| | | | time, spatial | | |
| | | | direction | | |
| | | | info, geo- | | |
| | | | coordinates, | | |
| | | | . . . , trp type, | | |
| | | | on-demand prs, | | |
| | | | trp tx teg, beam | | |
| | | | antenna info) | | |

In the example shown above, the request 252 includes a request for on-demand PRS TRP information for a TRP. Thus, as explained in detail below, in response to receiving the request 252, the NN 204 may transmit to the NN 202 the requested PRS TRP information.

In some embodiments, the request may be for on-demand PRS TRP information for a specific UE type (e.g., RedCap UEs), on-demand PRS TRP information for extended PRS repetition frequency values, or enhanced on-demand PRS TRP Information. The on-demand PRS TRP information for the specific UE type may be on-demand PRS TRP information suitable for the specific UE type. The on-demand PRS TRP information for extended PRS repetition factor values may be on-demand PRS TRP information including extended PRS repetition factor values. The enhanced on-demand PRS TRP information may be on-demand PRS TRP information with advanced features (e.g., extended repetition factor values, longer repetition factors, etc.). In such embodiments, the NN 204 may include the requested particular on-demand PRS TRP information in a response message and send the response message to the NN 204. The response message may also include an indicator indicating the specific UE type and/or usage of one or more extended PRS repetition factor values.

Also, in some embodiments, the request 252 may also include a request for PRS configuration. The request for PRS configuration may be a request for PRS configuration associated with a specific UE type, a request for PRS configuration with extended PRS repetition factor values (e.g., the request may expressly indicate one or more extended PRS repetition factor values), or a request for PRS configuration with longer PRS repletion factors. In such embodiments, upon receiving the request, the NN 204 may transmit its PRS configuration for the TRP in accordance with the requested PRS configuration.

In response to receiving the request 252, the NN 204 transmits to the NN 202 a response message 254 (e.g., TRP Information Response) containing the requested information of the TPR(s) hosted by the NG-RAN node 104 or the TRP in gNB-CU (hereinafter, “TRP information”).

Even though the TRP information may be associated with more than one TRPs, for simple explanation purpose, it will be assumed in this disclosure that the TRP information included in the response message 254 is associated with a single specific TRP.

According to some embodiments, the response message 254 may include a first IE containing information of the specific TRP hosted by the NG-RAN node 104 or the TRP in gNB-CU. Table 1 provided below shows an example of information included in the response message 254.

TABLE 1

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.3 | YES | reject |
| NRPPa Transaction | M | | 9.2.4 | — | |
| ID | | | | | |
| TRP Information | | 1 | | YES | ignore |
| List | | | | | |
| >TRP Information | M | 1 . . . | | EACH | ignore |
| Item | | <maxnoTRPs> | | | |
| >>TRP Information | M | | 9.2.25 | — | |
| Criticality | O | | 9.2.2 | YES | ignore |
| Diagnostics | | | | | |

In the example shown in Table 1 provided above, the TPR Information IE is an example of the first IE containing information of the specific TRP hosted by the NG-RAN node 104 or the TRP in gNB-CU.

According to some embodiments, the first IE (e.g., the TRP Information IE) which contains the information about the specific TRP may include a second IE which contains information related to one or more configurations related to PRS transmission for the specific TRP. Table 2 provided below shows an example of information included in the first IE.

TABLE 2

| | | | IE Type and | Semantics | | Assigned |
|---|---|---|---|---|---|---|
| IE/Group Name | Presence | Range | Reference | Description | Criticality | Criticality |
| TRP ID | M | | 9.2.24 | | — | |
| TRP Information | | 1 . . . | | | — | |
| Type | | <maxnoTRPInfoTypes> | | | | |
| >CHOICE TRP | M | | | | — | |
| Information Item | | | | | | |
| >>NR PCI | M | | INTEGER | NR Physical | — | |
| | | | (0 . . . 1007) | Cell ID | | |
| >>NR CGI | M | | 9.2.9 | | — | |
| >>NR ARFCN | M | | INTEGER | | — | |
| | | | (0 . . . 3279165) | | | |
| >>PRS | M | | 9.2.44 | | — | |
| Configuration | | | | | | |
| >>SSB Information | M | | 9.2.54 | | — | |
| >>SFN | M | | Relative Time | | — | |
| Initialisation | | | 1900 | | | |
| Time | | | 9.2.36 | | | |
| >>Spatial | M | | 9.2.45 | | — | |
| Direction | | | | | | |
| Information | | | | | | |
| >>Geographical | M | | 9.2.46 | | — | |
| Coordinates | | | | | | |
| >>TRP type | M | | ENUMERATED | TS 38.305 | YES | reject |
| | | | (prs-only-tp, | [18] | | |
| | | | srs-only-rp, tp, | | | |
| | | | rp, trp . . . ) | | | |
| >>On-demand PRS | M | | 9.2.65 | | YES | reject |
| TRP Information | | | | | | |
| >>TRP Tx TEG | M | | 9.2.79 | | YES | reject |
| Association | | | | | | |
| >>TRP Beam | M | | 9.2.82 | | YES | reject |
| Antenna | | | | | | |
| Information | | | | | | |

In the example shown in Table 2 provided above, the on-demand PRS TRP Information IE is an example of the second IE which contains information related to one or more configurations related to PRS transmission for the specific TRP (hereinafter, “PRS TRP information”).

A PRS repetition factor value for normal NR UEs is normally within a range between 1 and 32 (i.e., [1,32]). However, as explained above, for some RedCap UEs, an extended range of PRS repetition factor value (i.e., [1,N] where N is greater than 32) and/or an extended PRS repetition factor value (i.e., the PRS repetition factor value which is greater than 32) may be needed. Thus, in case the TRP for which the TRP information is transmitted from the NN 204 to the NN 202 serves many RedCap UEs, the NN 204 may need to indicate to the NN 202 that an extended PRS repetition factor value is one of allowed PRS repetition factor values.

Accordingly, in some embodiments of this disclosure, the response message 254 may include an extended PRS repetition factor value.

More specifically, in one example, the response message 254 may include the on-demand PRS TRP information IE shown in Table 2, and the on-demand PRS TRP information IE may comprise the Allowed Resource Repetition Factor Values IE as shown in Table 3 provided below. The Allowed Resource Repetition Factor Values IE may comprise 8 bits, and one or more of the seventh and eighth bits may indicate one or more extended PRS repetition factor values. Table 3 below shows an example of information included in the on-demand PRS TRP information IE.

TABLE 3

| | | IE Type and | |
|---|---|---|---|
| IE/Group Name | Presence | Reference | Semantics Description |
| On-demand PRS Request | M | BIT STRING | Each position in the bitmap |
| Allowed | | (SIZE(16)) | represents an on-demand PRS |
| | | | transmission parameter: |
| | | | first bit: Resource Set Periodicity |
| | | | second bit: PRS Bandwidth |
| | | | third bit: Resource Repetition |
| | | | Factor |
| | | | fourth bit: Resource Number of |
| | | | Symbols |
| | | | fifth bit: Comb Size |
| | | | sixth bit: Number of Frequency |
| | | | Layers |
| | | | seventh bit: Start Time and |
| | | | Duration |
| | | | eighth bit: Off Indication |
| | | | ninth bit: QCL Information |
| | | | Other bits reserved for future |
| | | | use. Value ‘1’ indicates ‘request |
| | | | allowed’, Value ‘0’ indicates |
| | | | ‘request not allowed’. |
| Allowed Resource Set | O | BIT STRING | This IE applies only if the first bit |
| Periodicity Values | | (SIZE(24)) | of the On-demand PRS Request |
| | | | Allowed IE is set to ‘1’. |
| | | | Each position in the bitmap |
| | | | represents a value of the |
| | | | Resource Set Periodicity IE |
| | | | defined in subclause 9.2.61, first |
| | | | bit = 4 and so on. Bits 21-24 are |
| | | | reserved for future use. Value ‘1’ |
| | | | indicates ‘request allowed’, Value |
| | | | ‘0’ indicates ‘request not |
| | | | allowed’. If this IE is absent, all |
| | | | Resource Set Periodicity values |
| | | | are allowed to be requested. |
| Allowed PRS Bandwidth | O | BIT STRING | This IE applies only if the second |
| Values | | (SIZE(64)) | bit of the On-demand PRS |
| | | | Request Allowed IE is set to ‘1’. |
| | | | Each position in the bitmap |
| | | | represents a value of the PRS |
| | | | Bandwidth IE defined in |
| | | | subclause 9.2.61, first bit = 1 and |
| | | | so on. Bit 64 is reserved for |
| | | | future use. Value ‘1’ indicates |
| | | | ‘request allowed’, Value ‘0’ |
| | | | indicates ‘request not allowed’. If |
| | | | this IE is absent, all PRS |
| | | | Bandwidth values are allowed to |
| | | | be requested. |
| Allowed Resource | O | BIT STRING | This IE applies only if the third bit |
| Repetition Factor Values | | (SIZE(8)) | of the On-demand PRS Request |
| | | | Allowed IE is set to ‘1’. |
| | | | Each position in the bitmap |
| | | | represents a value of the |
| | | | Resource Repetition Factor IE |
| | | | defined in subclause 9.2.61, first |
| | | | bit = rf1 and so on. Bit 8 |
| | | | indicates a value of an extended |
| | | | PRS repetition factor. Value ‘1’ |
| | | | indicates ‘request allowed’, Value |
| | | | ‘0’ indicates ‘request not |
| | | | allowed’. If this IE is absent, all |
| | | | Resource Repetition Factor |
| | | | values are allowed to be |
| | | | requested. |
| Allowed Resource Number | O | BIT STRING | This IE applies only if the fourth |
| of Symbols Values | | (SIZE(8)) | bit of the On-demand PRS |
| | | | Request Allowed IE is set to ‘1’. |
| | | | Each position in the bitmap |
| | | | represents a value of the |
| | | | Resource Number of Symbols IE |
| | | | defined in subclause 9.2.61, first |
| | | | bit = n2 and so on. Bits 5-8 are |
| | | | reserved for future use. Value ‘1’ |
| | | | indicates ‘request allowed’, Value |
| | | | ‘0’ indicates ‘request not |
| | | | allowed’. If this IE is absent, all |
| | | | Resource Number of Symbols |
| | | | values are allowed to be |
| | | | requested. |
| Allowed Comb Size Values | O | BIT STRING | This IE applies only if the fifth bit |
| | | (SIZE(8)) | of the On-demand PRS Request |
| | | | Allowed IE is set to ‘1’. |
| | | | Each position in the bitmap |
| | | | represents a value of the Comb |
| | | | Size IE defined in subclause |
| | | | 9.2.61, first bit = 2 and so on. |
| | | | Bits 5-8 are reserved for future |
| | | | use. Value ‘1’ indicates ‘request |
| | | | allowed’, Value ‘0’ indicates |
| | | | ‘request not allowed’. If this IE is |
| | | | absent, all Comb Size values are |
| | | | allowed to be requested. |

Furthermore, in some embodiments, the response message 254 may also include one or more bits indicating whether one or more extended PRS repetition factor values indicated in the IE included in the response message 254 is allowed for the TRP. More specifically, in the example shown in Table 3 above, a bit included in the on-demand PRS Request Allowed IE (e.g., the third bit) may indicate whether the resource repetition factor values included in the Allowed Resource Repetition Factor Values IE are allowed for the TRP.

As explained above, in some embodiments, the response message 254 includes a single IE (e.g., the “Allowed Resource Repetition Factor Values” IE shown in Table 3) which can contain non-extended PRS repetition factor value(s) (i.e., any of 1, 2, 4, 6, 8, 16, 32) as well as extended PRS repetition factor value(s) (i.e., a value that is greater than 32). However, in some embodiments, the response message 254 may include two different IEs-one IE containing non-extended PRS repetition factor value(s) and another IE containing extended PRS repetition factor value(s). Table 4 below shows an example of information included in the on-demand PRS TRP information IE, according to these embodiments.

TABLE 4

| | | IE Type and | |
|---|---|---|---|
| IE/Group Name | Presence | Reference | Semantics Description |
| On-demand PRS Request | M | BIT STRING | Each position in the bitmap |
| Allowed | | (SIZE(16)) | represents an on-demand PRS |
| | | | transmission parameter: |
| | | | first bit: Resource Set Periodicity |
| | | | second bit: PRS Bandwidth |
| | | | third bit: Resource Repetition |
| | | | Factor |
| | | | fourth bit: Resource Number of |
| | | | Symbols |
| | | | fifth bit: Comb Size |
| | | | sixth bit: Number of Frequency |
| | | | Layers |
| | | | seventh bit: Start Time and |
| | | | Duration |
| | | | eighth bit: Off Indication |
| | | | ninth bit: QCL Information |
| | | | one or more of tenth through |
| | | | sixteenth bits: Extended |
| | | | Resource Repetition Factor |
| | | | Other bits reserved for future |
| | | | use. Value ‘1’ indicates ‘request |
| | | | allowed’, Value ‘0’ indicates |
| | | | ‘request not allowed’. |
| Allowed Resource Set | O | BIT STRING | This IE applies only if the first bit |
| Periodicity Values | | (SIZE(24)) | of the On-demand PRS Request |
| | | | Allowed IE is set to ‘1’. |
| | | | Each position in the bitmap |
| | | | represents a value of the |
| | | | Resource Set Periodicity IE |
| | | | defined in subclause 9.2.61, first |
| | | | bit = 4 and so on. Bits 21-24 are |
| | | | reserved for future use. Value ‘1’ |
| | | | indicates ‘request allowed’, Value |
| | | | ‘0’ indicates ‘request not |
| | | | allowed’. If this IE is absent, all |
| | | | Resource Set Periodicity values |
| | | | are allowed to be requested. |
| Allowed PRS Bandwidth | O | BIT STRING | This IE applies only if the second |
| Values | | (SIZE(64)) | bit of the On-demand PRS |
| | | | Request Allowed IE is set to ‘1’. |
| | | | Each position in the bitmap |
| | | | represents a value of the PRS |
| | | | Bandwidth IE defined in |
| | | | subclause 9.2.61, first bit = 1 and |
| | | | so on. Bit 64 is reserved for |
| | | | future use. Value ‘1’ indicates |
| | | | ‘request allowed’, Value ‘0’ |
| | | | indicates ‘request not allowed’. If |
| | | | this IE is absent, all PRS |
| | | | Bandwidth values are allowed to |
| | | | be requested. |
| Allowed Resource | O | BIT STRING | This IE applies only if the third bit |
| Repetition Factor Values | | (SIZE(8)) | of the On-demand PRS Request |
| | | | Allowed IE is set to ‘1’. |
| | | | Each position in the bitmap |
| | | | represents a value of the |
| | | | Resource Repetition Factor IE |
| | | | defined in subclause 9.2.61, first |
| | | | bit = rf1 and so on. Bit 8 is |
| | | | reserved for future use. Value ‘1’ |
| | | | indicates ‘request allowed’, Value |
| | | | ‘0‘ indicates ‘request not |
| | | | allowed’. If this IE is absent, all |
| | | | Resource Repetition Factor |
| | | | values are allowed to be |
| | | | requested. |
| Allowed Extended | O | BIT STRING | This IE applies only if the tenth |
| Resource Repetition | | | bit of the On-demand PRS |
| Factor Values | | | Request Allowed IE is set to ‘1’. |
| | | | Each position in the bitmap |
| | | | represents a value of the |
| | | | Resource Repetition Factor IE |
| | | | defined in subclause 9.2.61, first |
| | | | bit = rf64 and so on. Value ‘1’ |
| | | | indicates ‘request allowed’, Value |
| | | | ‘0’ indicates ‘request not |
| | | | allowed’. If this IE is absent, all |
| | | | Extended Resource Repetition |
| | | | Factor values are allowed to be |
| | | | requested. |
| Allowed Resource Number | O | BIT STRING | This IE applies only if the fourth |
| of Symbols Values | | (SIZE(8)) | bit of the On-demand PRS |
| | | | Request Allowed IE is set to ‘1’. |
| | | | Each position in the bitmap |
| | | | represents a value of the |
| | | | Resource Number of Symbols IE |
| | | | defined in subclause 9.2.61, first |
| | | | bit = n2 and so on. Bits 5-8 are |
| | | | reserved for future use. Value ‘1’ |
| | | | indicates ‘request allowed’, Value |
| | | | ‘0’ indicates ‘request not |
| | | | allowed’. If this IE is absent, all |
| | | | Resource Number of Symbols |
| | | | values are allowed to be |
| | | | requested. |
| Allowed Comb Size Values | O | BIT STRING | This IE applies only if the fifth bit |
| | | (SIZE(8)) | of the On-demand PRS Request |
| | | | Allowed IE is set to ‘1’. |
| | | | Each position in the bitmap |
| | | | represents a value of the Comb |
| | | | Size IE defined in subclause |
| | | | 9.2.61, first bit = 2 and so on. |
| | | | Bits 5-8 are reserved for future |
| | | | use. Value ‘1’ indicates ‘request |
| | | | allowed’, Value ‘0’ indicates |
| | | | ‘request not allowed’. If this IE is |
| | | | absent, all Comb Size values are |
| | | | allowed to be requested. |

In the example shown in Table 4 above, the on-demand PRS TRP information IE includes the Allowed Resource Repetition Factor Values IE indicating non-extended PRS repetition factor value(s) and the Allowed Extended Resource Repetition Factor Values IE indicating extended PRS repetition factor value(s).

In case the response message 254 includes two different IEs-one IE containing non-extended PRS repetition factor value(s) and another IE containing extended PRS repetition factor value(s), in some embodiments, the response message 254 may include one or more bits indicating whether the usage of the extended range of a PRS repetition factor value is allowed for the TPR. In other words, said one or more bits may indicate the existence or the usage of the IE containing extended PRS repetition factor value(s). For example, in the example shown in Table 4 above, some of the bits of the on-demand PRS Request Allowed IE (e.g., any one or more bits among the tenth through sixteenth bits) may indicate the existence or the usage of the Allowed Extended Resource Repetition Factor Values IE which contains extended PRS repetition factor value(s).

In some embodiments, the response message 254 may also indicate a UE type associated with the TRP. Examples of the UE type include LPHAP, RedCap, extended RedCap (eRedCap) including RedCap 1Rx and RedCap 2 Rx, and normal. Upon receiving the response message 254, based on the indicated UE type, the NN 202 may determine PRS configuration to be recommended to the NN 204. For example, in case the UE type indicated by the response message 254 is LPHAP, the NN 202 may include one or more extended PRS repetition factor values in the PRS configuration and transmit the PRS configuration to the NN 204. The process of exchanging the PRS configuration is explained below.

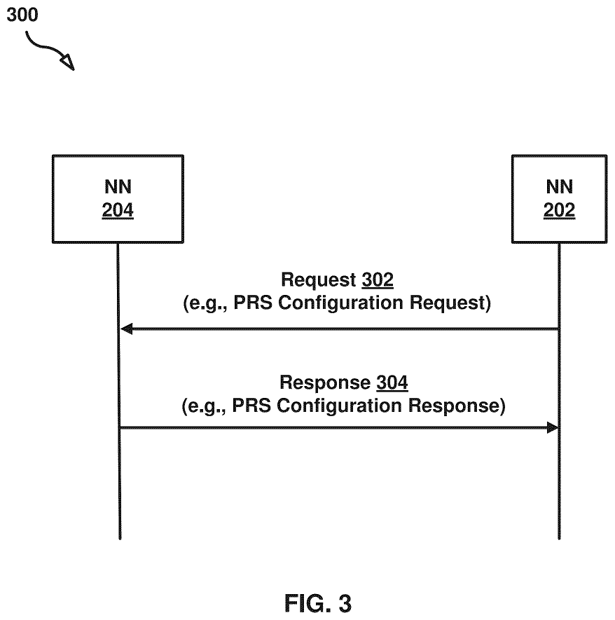

FIG. 3 is a process 300 for exchanging PRS configuration information. The process 300 comprises the NN 202 (e.g., NN 108) transmitting to the NN 204 a request 302 (e.g., PRS Configuration Request”) to configure or update (e.g., turn off) PRS transmission. The request 302 may include PRS configuration for a TRP. In response to receiving the request 302, the NN 204 transmits to the NN 202 a response message 304 acknowledging the configuration or the update of PRS transmission.

In some embodiments, the request 302 may include one or more extended PRS repetition factor values. By including one or more extended PRS repetition factor values, the request 302 may trigger the NN 204 to configure or update PRS transmission for the specific TRP to use the extended PRS repetition factor values. Table 5 provided below is an example of information included in the request 302.

TABLE 5

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.3 | YES | reject |
| NRPPa | M | | 9.2.4 | — | |
| Transaction ID | | | | | |
| PRS | M | | ENUMERATED | YES | reject |
| Configuration | | | (configure, off, | | |
| Request Type | | | . . . ) | | |
| PRS TRP List | | 1 | | YES | ignore |
| >PRS TRP Item | | 1 . . . | | EACH | ignore |
| | | <maxnoTRPs> | | | |
| >>TRP ID | M | | 9.2.24 | — | |
| >>Requested DL | C-ifConf | | 9.2.61 | — | |
| PRS Transmission | | | | | |
| Characteristics | | | | | |
| >>PRS | C-ifOff | | 9.2.64 | — | |
| Transmission | | | | | |
| Off Information | | | | | |

As shown above, the request 302 may include the Requested DL PRS Transmission Characteristics IE. An example of information included in the Requested DL PRS Transmission Characteristics IE is shown in Table 6 provided below.

TABLE 6

| | | | IE Type and | |
|---|---|---|---|---|
| IE/Group Name | Presence | Range | Reference | Semantics Description |
| PRS Resource Set List | | 1 | | |
| >PRS Resource Set Item | | 1 . . . | | |
| | | <maxnoofPRSresourceSet> | | |
| >>PRS Resource Set | M | | INTEGER(0 . . . 7) | |
| ID | | | | |
| >>Subcarrier Spacing | M | | ENUMERATED(kHz | |
| | | | 15, kHz30, kHz60, | |
| | | | kHz120, . . .) | |
| >>PRS bandwidth | M | | INTEGER(1 . . . 63) | 24, 28, . . . , 272 PRBs |
| >>Start PRB | M | | INTEGER(0 . . . 2176) | Starting PRB to Point A |
| >>Point A | M | | INTEGER | NR ARFCN |
| | | | (0 . . . 3279165) | |
| >>Comb Size | M | | ENUMERATED(2, | |
| | | | 4, 6, 12, . . .) | |
| >>CP Type | M | | ENUMERATED(normal, | |
| | | | extended, . . .) | |
| >>Resource Set | M | | ENUMERATED(4, 5, | |
| Periodicity | | | 8, 10, 16, 20, 32, 40, 64, | |
| | | | 80, 160, 320, 640, 1280, | |
| | | | 2560, 5120, 10240, | |
| | | | 20480, 40960, 81920, . . .) | |
| >>Resource Set Slot | M | | INTEGER(0 . . . | |
| Offset | | | 81919, . . .) | |
| >>Resource Repetition | M | | ENUMERATED(rf1, rf2, | values rf64, rf128 are |
| Factor | | | rf4, rf6, rf8, rf16, | used for redcap freq |
| | | | rf32, . . . , rf64, rf128) | hopping |
| >>Resource Time Gap | M | | ENUMERATED(tg1, tg2, | values tg64, tg128are |
| | | | tg4, tg8, tg16, tg32, . . . , | used for redcap freq |
| | | | tg64, tg128) | hopping |
| >>Resource Number of | M | | ENUMERATED(n2, | |
| Symbols | | | n4, n6, n12, . . .) | |
| >>PRS Muting | O | | | |
| >>>Option1 | O | | | |
| >>>>Muting Pattern | M | | DL-PRS Muting | Muting pattern option 1 is used to |
| | | | Pattern | mute the whole PRS resource |
| | | | 9.2.56 | set (within a period) |
| >>>>Muting Bit | M | | ENUMERATED(1, 2, | |
| Repetition Factor | | | 4, 8, . . .) | |
| >>>Option2 | O | | | |
| >>>>Muting Pattern | M | | DL-PRS Muting | Muting pattern option 2 is used to |
| | | | Pattern | mute the selected repetition of |
| | | | 9.2.56 | the resource set (within the |
| | | | | period) |
| >>PRS Resource | M | | INTEGER(−60 . . . 50) | |
| Transmit Power | | | | |
| >>PRS Resource List | | 1 | | Corresponds to information |
| | | | | provided in NR-DL-PRS- |
| | | | | Resource contained in NR-DL- |
| | | | | PRS-Info IE as defined in TS |
| | | | | 37.355[14] |
| >>>PRS Resource | | 1 . . . | | |
| Item | | <maxnoofPRSresources> | | |
| >>>>PRS Resource | M | | INTEGER(0 . . . 63) | |
| ID | | | | |
| >>>>Sequence ID | M | | INTEGER(0 . . . 4095) | |
| >>>>RE Offset | M | | INTEGER(0 . . . 11, . . .) | |
| >>>>Resource Slot | M | | INTEGER(0 . . . 511) | |
| Offset | | | | |
| >>>>Resource | M | | INTEGER(0 . . . 12) | |
| Symbol Offset | | | | |
| >>>>CHOICE QCL | O | | | |
| Info | | | | |
| >>>>>SSB | | | | |
| >>>>>>NR PCI | M | | INTEGER(0 . . . 1007) | |
| >>>>>>SSB | O | | INTEGER(0 . . . 63) | |
| Index | | | | |
| >>>>>DL-PRS | | | | |
| >>>>>>QCL | M | | INTEGER(0 . . . 7) | |
| Source PRS | | | | |
| Resource Set ID | | | | |
| >>>>>>QCL | O | | INTEGER(0 . . . 63) | If it is absent, the QCL source |
| Source PRS | | | | PRS resource ID is the same as |
| Resource ID | | | | the PRS resource ID |

As shown above, in the example provided in Table 6 above, the Requested DL PRS Transmission Characteristics IE included in the request 302 may include the Resource Repetition Factor IE which includes one or more PRS repetition factor values configured for the TPR. The PRS repetition factor values may include one or more extended PRS repetition factor values (e.g., rf64, rf128, rf40, rf80, rf160).

As explained above, the request 302 that the NN 202 transmits to the NN 204 may include PRS configuration for a TRP. In determining the PRS configuration for the TRP, according to some embodiments, the NN 202 may rely on a majority of types of UEs served by the TRP. For example, among the UEs served by the TRP, if more than 80% of the UEs are RedCap UEs, then the NN 202 may select PRS characteristics suitable for RedCap UE. For the remaining 20% of UEs that are not RedCap UEs, the NN 202 may select a different positioning method or fuse different positioning methods with PRS based positioning method (i.e., use a hybrid positioning). Thus, in these embodiments, the NN 202 may need to keep track of percentages of different types of UEs served by the TRP, and determine the PRS configuration for the TPR according to the tracked percentages. Table 7 provides an example of different PRS configurations for different types of UEs.

TABLE 7

| UE Type | RedCap | LPHAP | Normal UE |
|---|---|---|---|
| PRS | PRS Periodicity: P1 | PRS Periodicity: P2 | PRS Periodicity: P3 |
| Characteristics | Bandwidth: B1 | Bandwidth: B2 | Bandwidth: B3 |
| | Hopping Need: Yes | Hopping Need: No | Hopping need: Off |
| | Rep. Factor: Large | Rep. Factor: Large | Rep. Factor: Small |
| | NrOfTRPs: T1 | NrOfTRPs: T2 | NrOfTRPs: T3 |
| | Nr. OfPFL: F1 | Nr. OfPFL: F2 | Nr. OfPFL: F3 |
| | Nr. OfResourceSet: RS1 | Nr. OfResourceSet: RS2 | Nr. OfResourceSet: RS3 |
| | Nr. OfResources: R1 | Nr. OfResources: R2 | Nr. OfResources: R3 |

In some embodiments, the request 302 may also indicate a UE type. Examples of the UE type include LPHAP, RedCap, extended RedCap (eRedCap) including RedCap 1Rx and RedCap 2 Rx, and normal. In such embodiments, upon receiving the request 302, the NN 204 may configure the TRP in accordance with the PRS configuration and the indicated UE type. For example, in case the UE type indicated by the request 302 is LPHAP, the NN 204 may configure the TRP such that one or more extended PRS repetition factor values is to be used for the TRP.

In other embodiments, the request 302 may not indicate any UE type. In such embodiments, because the NN 204 already has information about the UE type associated with the TRP, the NN 204 may configure the TRP in accordance with the received PRS configuration and the UE type that the NN 204 has.

As discussed above, in some embodiments, the NN 202 keeps track of percentages of different types of UEs served by the TRP, and determine the PRS configuration for the TPR according to the tracked percentages. In keeping track of percentages of different UE types, the NN 202 may rely on information provided by UEs and/or a core network (CN) (e.g., AMF or AMF plus unified data management (UDM) node). For example, in some embodiments, a UE or the CN may determine the UE type for the UE based on the PRS characteristics associated with the UE and may inform the NN 202 its determined UE type. For example, if the UE is a RedCap UE but may be configured to perform a positioning task which requires infrequent regular positioning update such as low-power high-accuracy positioning (LPHAP) use cases, then the UE or CN may simply select the type of the UE as LPHAP and indicate to the NN 202 (e.g., LMF).

Thus, in some embodiments, a UE may transmit to the NN 202 a message requesting use of one or more extended PRS repetition factor values and/or its determined UE type. In some embodiments, this message is a request for on-demand PRS from the NN 202. More specifically, one example of the message is NR-On-Demand-DL-PRS-Request including NR-On-Demand-DL-PRS-Information IE.

The message may include an IE that expressly identifies one or more of: requested extended PRS repetition factor values, its UE type determined based on its actual UE type, and/or its UE type determined based on one or more positioning tasks that the UE is configured to perform. An example of the IE is provided below.

-- ASN1START
NR-On-Demand-DL-PRS-Information-r17 ::= SEQUENCE (SIZE
(1..nrMaxFreqLayers-r16)) OF

NR-On-Demand-DL-PRS-

PerFreqLayer-r17
NR-On-Demand-DL-PRS-PerFreqLayer-r17 ::= SEQUENCE {

| | |
|---|---|
| dl-prs-FrequencyRangeReq-r17 | ENUMERATED { fr1, fr2, |

...},

| | |
|---|---|
| dl-prs-ResourceSetPeriodicityReg-r17 | ENUMERATED { p4, p5, |

p8, p10, p16, p20, p32, p40,

p64, p80, p160, p320, p640,

p1280, p2560,

p5120, p10240, p20480,

p40960, p81920, ...,

p128-v1760, p256-v1760,

p512-v1760}
OPTIONAL,

| | |
|---|---|
| dl-prs-ResourceBandwidthReq-r17 | INTEGER (1..63) |

OPTIONAL,

| | |
|---|---|
| dl-prs-ResourceRepetitionFactorReq-r17 | ENUMERATED {n2, n4, n6, |
| | n8, n16, n32, n64, n128} |

OPTIONAL,

| | |
|---|---|
| dl-prs-NumSymbolsReq-r17 | ENUMERATED {n2, n4, n6, n12, |

...} OPTIONAL,

| | |
|---|---|
| dl-prs-CombSizeN-Reg-r17 | ENUMERATED {n2, n4, n6, n12, |

...} OPTIONAL,

| | |
|---|---|
| dl-prs-QCL-InformationReqTRPlist-r17 | DL-PRS-QCL- |

InformationReqTRPlist-r17 OPTIONAL,
...
}
DL-PRS-QCL-InformationReqTRPlist-r17 ::= SEQUENCE (SIZE
(1..nrMaxTRPsPerFreq-r16)) OF

DL-PRS-OCL-

InformationRegPerTRP-r17
DL-PRS-QCL-InformationReqPerTRP-r17 ::= SEQUENCE {

| | |
|---|---|
| dl-PRS-ID-r17 | INTEGER (0..255), |
| nr-PhysCellID-r17 | NR-PhysCellID-r16 |

OPTIONAL,

| | |
|---|---|
| nr-CellGlobalID-r17 | NCGI-r15 |

OPTIONAL,

| | |
|---|---|
| nr-ARFCN-r17 | ARFCN-ValueNR-r15 |

```
  OPTIONAL,
  dl-prs-QCL-InformationReqSet-r17SEQUENCE (SIZE
(1..nrMaxSetsPerTrpPerFreqLayer-r16)) OF
```

DL-PRS-QCL-InfoReq-r17,

...
}
DL-PRS-QCL-InfoReq-r17 ::= SEQUENCE {

| | |
|---|---|
| nr-DL-PRS-ResourceSetID-r17 | NR-DL-PRS-ResourceSetID- |

r16,

| | |
|---|---|
| dl-prs-QCL-InformationReq-r17 | CHOICE { |

dl-prs-QCL-InfoRecPerResourceSet-r17 DL-PRS-QCL-
Info-r16,

| | |
|---|---|
| dl-prs-QCL-Info-requested-r17 | NULL |

```
        },
  ...,
  [[
```

| | |
|---|---|
| dl-prs-QCL-InfoRecPerResource-r17 SEQUENCE | (SIZE |

(1..nrMaxResourcesPerSet-r16)) OF

DL-PRS-QCL-Info-r16

```
  OPTIONAL
  ]],
  [[
```

| | |
|---|---|
| prs-BasedUponUE-Type-r18 | ENUMERATED {lphap, redcap, |
| redcap 1rx, redcap 2rx, normal} | OPTIONAL, |
| prs-BasedUponApplication-r18 | ENUMERATED {lphap, redcap, |

redcap 1rx, redcap 2rx} OPTIONAL
]]
}
-- ASN1STOP

As shown above, a UE type for PRS configuration may be one of LPHAP, RedCap, extended RedCap (eRedCap) including RedCap 1Rx and RedCap 2 Rx, and normal.

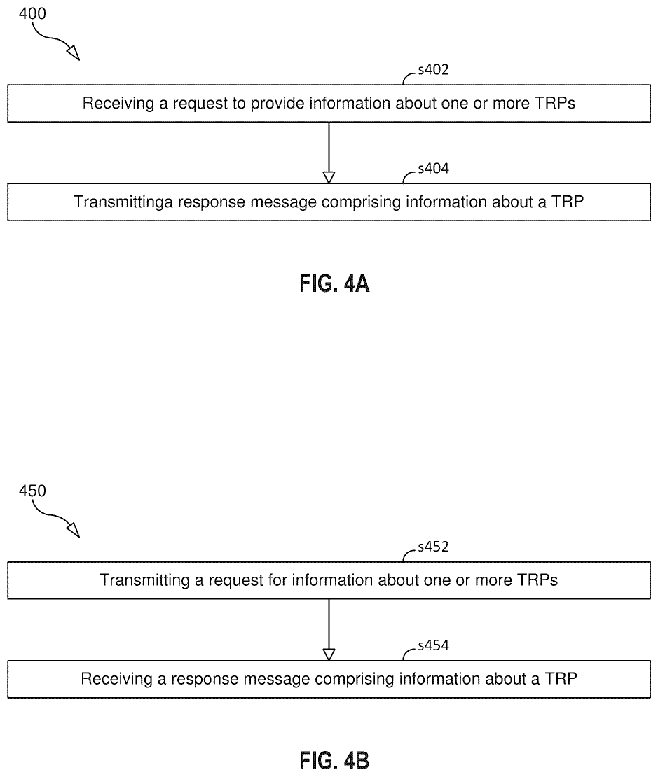

FIG. 4A shows a process 400 performed by a first NN (e.g., NN 204 or NN 104) according to some embodiments. The process 400 comprises steps s402 and s404. The step s402 comprises receiving, from a second NN (e.g., NN 108 or NN 202), a request (e.g., 252) to provide information about one or more transmission and reception points, TRPs, associated with the first NN. Step s404 comprises, based at least on receiving the request, transmitting, to the second NN, a response message (e.g., 254) including information about a TRP. The information about the TRP indicates: whether usage of an extended range of a positioning reference signal, PRS, repetition factor value is allowed for the TRP, and/or one or more extended PRS repetition factor values.

In some embodiments, the request to provide information about one or more TRPs associated with the first NN comprises: a request to provide on-demand PRS information for a specific UE type, and/or a request to provide on-demand PRS information with extended PRS repetition factor values.

In some embodiments, the response message includes a first information element, IE, containing on-demand PRS information for the TRP, and the information about the TRP is included in the first IE.

In some embodiments, the on-demand PRS information for the TRP comprises: the on-demand PRS information for the specific UE type, and/or the on-demand PRS information with extended PRS repetition factor values.

In some embodiments, the first IE comprises a second IE containing a plurality of bits and one or more additional bits, the plurality of bits represents on-demand PRS transmission parameters, and said one or more additional bits indicate whether the usage of the extended range of a PRS repetition factor value is allowed for the TRP.

In some embodiments, each of said one or more additional bits is one of tenth through sixteenth bits included in the second IE.

In some embodiments, said one or more additional bits indicate an existence and/or a usage of a third IE included in the first IE, and the third IE contains said one or more extended PRS repetition values.

In some embodiments, the first IE further comprises a fourth IE containing one or more non-extended PRS repetition values.

In some embodiments, the first IE comprises a second IE containing one or more non-extended PRS repetition values and said one or more extended PRS repetition values.

In some embodiments, the request message comprises an information element, IE, which contains PRS configuration for the TRP, and the IE further contains at least one extended PRS repetition factor value.

In some embodiments, the PRS configuration for the TRP is associated with a specific type of UEs.

In some embodiments, the PRS configuration is determined based on a majority type of UEs served by the TRP and/or a majority type of UEs which needs to measure PRS from the TRP.

In some embodiments, the process 400 comprises receiving, from the second NN, a request for configuring or updating PRS transmission, wherein the request includes PRS configuration information for the TRP, wherein the PRS configuration information for the TRP comprises at least one extended PRS repetition factor value allowed for the TRP.

In some embodiments, the request for configuring or updating PRS transmission comprises an information element which contains requested PRS configuration for the TRP, and the IE containing the requested PRS configuration also contains said at least one extended PRS repetition value.

In some embodiments, the request for configuring or updating PRS transmission identifies a type of a user equipment, which is associated with the requested PRS configuration.

In some embodiments, the requested PRS configuration is determined based on a majority type of UEs served by the TRP and/or a majority type of UEs which need to measure PRS from the TRP.

In some embodiments, the majority type of UEs served by the TRP or the majority type of UEs which need to measure PRS from the TRP is determined by the UE or a core network, CN.

In some embodiments, the type of a UE is selected from a reduced capability, RedCap, UE, a normal UE, and a low power high accuracy positioning, LPHAP, UE.

In some embodiments, the first NN is a next-generation radio access network, NG-RAN, node and the second NN is a location management function, LMF, or the first NN is a gNB-distributed unit, gNB-DU, and the second NN is a gNB-centralized unit, CU.

FIG. 4B shows a process 450 performed by a first NN (e.g., 202/108) according to some embodiments. The process 450 comprises steps s452 and s454. The step s452 comprises transmitting, to a second NN (e.g., 204/104), a request (e.g., 252) to provide information about one or more transmission and reception points, TRPs, associated with the second NN. The step s454 comprises, based at least on transmitting the request, receiving, from the second NN, a response message (e.g., 254) including information about a TRP. The information about the TRP indicates: whether usage of an extended range of a positioning reference signal, PRS, repetition factor value is allowed for the TRP, and/or one or more extended PRS repetition factor values.

In some embodiments, the request to provide information about one or more TRPs associated with the second NN comprises: a request to provide on-demand PRS information for a specific UE type, and/or a request to provide on-demand PRS information with extended PRS repetition factor values.

In some embodiments, the response message includes a first information element, IE, containing on-demand PRS information for the TRP, and the information about the TRP is included in the first IE.

In some embodiments, the on-demand PRS information for the TRP comprises: the on-demand PRS information for the specific UE type, and/or the on-demand PRS information with extended PRS repetition factor values.

In some embodiments, the first IE comprises a second IE containing a plurality of bits and one more additional bits, the plurality of bits represents on-demand PRS transmission parameters, and said one or more additional bits indicate whether the usage of the extended range of a PRS repetition factor value is allowed for the TRP.

In some embodiments, each of said one or more additional bits is any one of tenth through sixteenth bits included in the second IE.

In some embodiments, said one or more additional bits indicate an existence and/or a usage of a third IE included in the first IE, and the third IE contains said one or more extended PRS repetition values.

In some embodiments, the first IE further comprises a fourth IE containing one or more non-extended PRS repetition values.

In some embodiments, the first IE comprises a second IE containing one or more non-extended PRS repetition values and said one or more extended PRS repetition values.

In some embodiments, the request message comprises an information element, IE, which contains PRS configuration for the TRP, and the IE further contains at least one extended PRS repetition factor value.

In some embodiments, the PRS configuration for the TRP is associated with a specific type of UEs.

In some embodiments, the PRS configuration is determined based on a majority type of UEs served by the TRP and/or a majority type of UEs which needs to measure PRS from the TRP.

In some embodiments, the process 500 further comprises transmitting, to the second NN, a request for configuring or updating PRS transmission, wherein the request includes PRS configuration information for the TRP, wherein the PRS configuration information for the TRP comprises at least one extended PRS repetition factor value allowed for the TRP.

In some embodiments, the request for configuring or updating PRS transmission comprises an information element which contains requested PRS configuration for the TRP, and the IE containing the requested PRS configuration also contains said at least one extended PRS repetition value.

In some embodiments, the request for configuring or updating PRS transmission identifies a type of a user equipment, which is associated with the requested PRS configuration.

In some embodiments, the process 500 further comprises collecting information about types of UEs served by the TRP, wherein the requested PRS configuration is determined based on a majority type of the UEs served by the TRP and/or a majority type of UEs which need to measure PRS from the TRP.

In some embodiments, the majority type of UEs served by the TRP and/or the majority type of UEs which need to measure PRS from the TRP is determined by the UE or a core network, CN.

In some embodiments, the type of a UE is selected from a reduced capability, RedCap, UE, a normal UE, and a low power high accuracy positioning, LPHAP, UE.

In some embodiments, the second NN is a next-generation radio access network, NG-RAN, node and the first NN is a location management function, LMF, or the second NN is a gNB-distributed unit, gNB-DU, and the first NN is a gNB-centralized unit, CU.

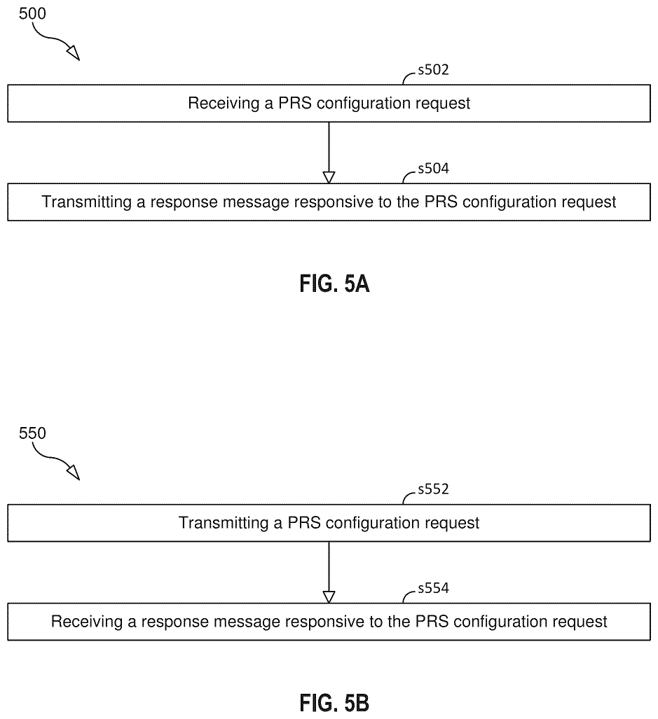

FIG. 5A shows a process 500 performed by a first NN (e.g., 204) according to some embodiments. The process 500 comprises steps s502 and s504. Step s502 comprises receiving, from a second network node, a configuration request message (e.g., a PRS configuration request message) for on-demand positioning reference signal (PRS) configuration with at least a first transmission and reception point (TRP) associated with the first network node, wherein the configuration request message comprises an extended PRS repetition factor value for the first TRP. Step s504 comprises, after receiving the request message, transmitting to the second network node a response message responsive to the request message, indicating that on-demand PRS configuration is configured or updated with at least the first TRP.

In some embodiments, the response message comprises an extended PRS repetition factor value being configured or updated with the first TRP (e.g., the response includes the extended PRS repetition factor value included in the request or a different extended PRS repetition factor value).

In some embodiments, the PRS is a downlink reference signal for positioning, or the PRS is an uplink reference signal for positioning.

In some embodiments, the on-demand PRS configuration with the first TRP is associated with a specific type of user equipment.

FIG. 5B shows a process 550 performed by a first NN (e.g., 202/108) according to some embodiments. The process 550 comprises steps s552 and s554. Step s552 comprises transmitting to a second network node a configuration request message (e.g., a PRS configuration request message) for on-demand positioning reference signal (PRS) configuration with at least a first transmission and reception point (TRP) associated with the first network node, wherein the configuration request message comprises an extended PRS repetition factor value for the first TRP. Step s554 comprises, after transmitting the configuration request message, receiving from the second network node a response message responsive to the request message, indicating that on-demand PRS configuration is configured or updated with at least the first TRP.

In some embodiments, the response message comprises an extended PRS repetition factor value being configured or updated with the first TRP.

In some embodiments, the PRS is a downlink reference signal for positioning, or the PRS is an uplink reference signal for positioning.

In some embodiments, the on-demand PRS configuration with the first TRP is associated with a specific type of user equipment.

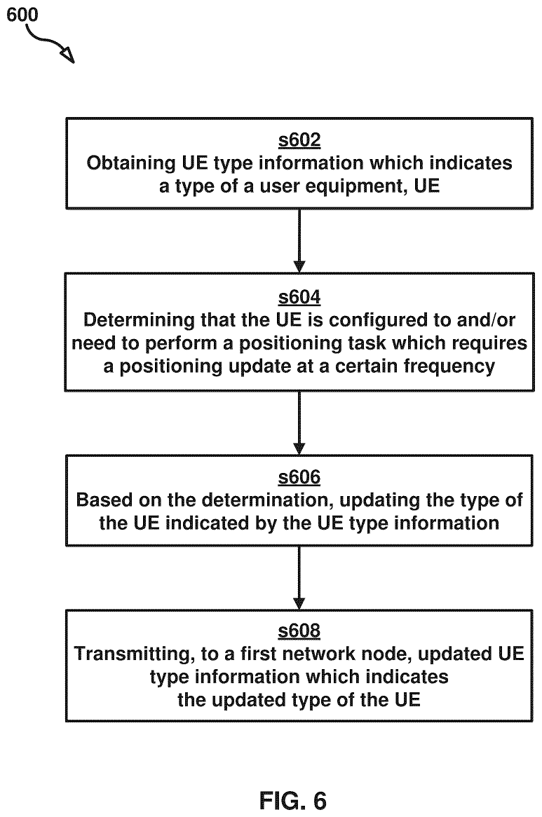

FIG. 6 shows a process 600 according to some embodiments. The process 600 comprises steps s602-s608. The step s602 comprises obtaining UE type information which indicates a type of a user equipment, UE. The step s604 comprises determining that the UE is configured to and/or need to perform a positioning task which requires a positioning update at a certain frequency, wherein the certain frequency satisfies a condition. The step s606 comprises, based on the determination, updating the type of the UE indicated by the UE type information. The step s608 comprises transmitting, to a first NN (e.g., 108), updated UE type information which indicates the updated type of the UE.

In some embodiments, the process 600 is performed by the UE (e.g., 102) or a second NN (e.g., 106).

In some embodiments, the updated type of the UE is one of a reduced capability, RedCap, UE, a normal UE, and a low power high accuracy positioning, LPHAP, UE.

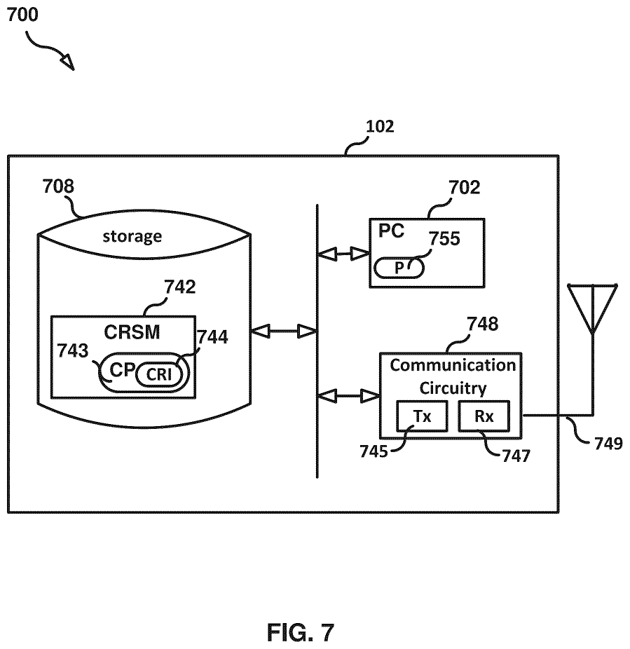

FIG. 7 is a block diagram of UE 102, according to some embodiments. As shown in FIG. 7, UE 102 may comprise: processing circuitry (PC) 702, which comprises one or more processors (P) 755 (e.g., one or more general purpose microprocessors and/or one or more other processors, such as an application specific integrated circuit (ASIC), field-programmable gate arrays (FPGAs), and the like); communication circuitry 748, which is coupled to an antenna arrangement 749 comprising one or more antennas and which comprises a transmitter (Tx) 745 and a receiver (Rx) 747 for enabling UE 102 to transmit data and receive data (e.g., wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes UE 102 to perform steps described herein (e.g., steps described herein with reference to the flow charts). In other embodiments, UE 102 may be configured to perform steps described herein without the need for code. That is, for example, PC 702 may consist merely of one or more ASICs. Hence, the features of the embodiments described herein may be implemented in hardware and/or software.

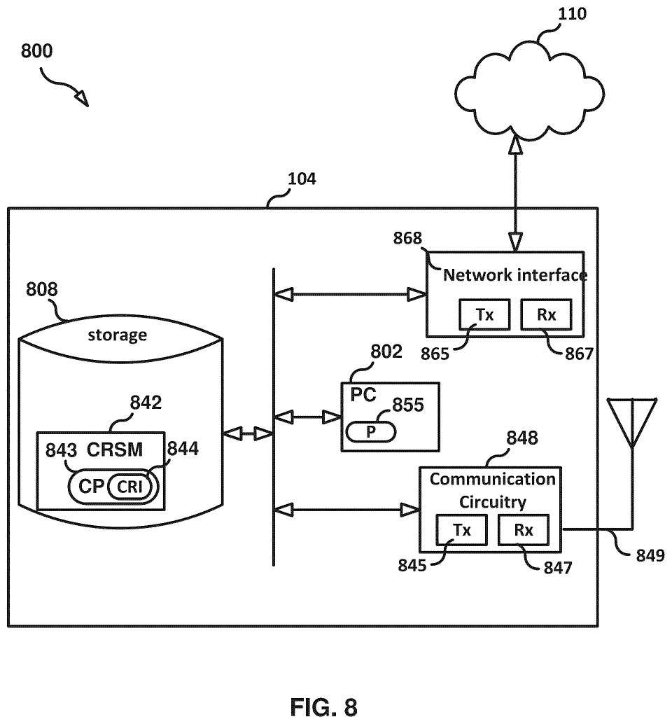

FIG. 8 is a block diagram of a NN implementing base station 104, according to some embodiments for performing the base station methods disclosed herein. As shown in FIG. 8, base station 104 may comprise: processing circuitry (PC) 802, which comprises one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., base station may be a distributed computing apparatus or a monolithic computing apparatus); a network interface 868 comprising a transmitter (Tx) 865 and a receiver (Rx) 867 for enabling base station 104 to transmit data to and receive data from other nodes connected to a network 110 (e.g., an Internet Protocol (IP) network) to which network interface 868 is connected; communication circuitry 848 (e.g., radio transceiver circuitry comprising an Rx 847 and a Tx 845) coupled to an antenna system 849 for wireless communication with UEs or other nodes; and a storage unit (a.k.a., “data storage system”) 808, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes base station 104 to perform steps described herein (e.g., steps described herein with reference to one or more flow charts). In other embodiments, base station 104 may be configured to perform steps described herein without the need for code. That is, for example, PC 802 may consist merely of one or more ASICs. Hence, the features of the embodiments described herein may be implemented in hardware and/or software.

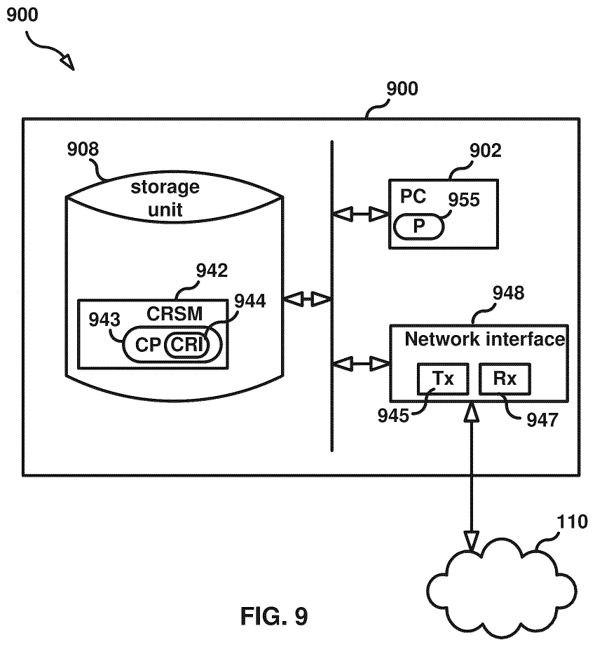

FIG. 9 is a block diagram of a NN implementing LMF 108, according to some embodiments. As shown in FIG. 9, NN 900 may comprise: processing circuitry (PC) 902, which comprises one or more processors (P) 955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (e.g., NN 900 may be a distributed computing apparatus comprising two or more computers or a monolithic computing apparatus consisting of a single computer); at least one network interface 948 (e.g., a physical interface or air interface) comprising a transmitter (Tx) 945 and a receiver (Rx) 947 for enabling NN 900 to transmit data to and receive data from other nodes connected to network 110 (e.g., an Internet Protocol (IP) network) to which network interface 948 is connected (physically or wirelessly) (e.g., network interface 948 may be coupled to an antenna arrangement comprising one or more antennas for enabling NN 900 to wirelessly transmit/receive data); and a storage unit (a.k.a., “data storage system”) 908, which may include one or more non-volatile storage devices and/or one or more volatile storage devices. In embodiments where PC 902 includes a programmable processor, a computer readable storage medium (CRSM) 942 may be provided. CRSM 942 may store a computer program (CP) 943 comprising computer readable instructions (CRI) 944. CRSM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes NN 900 to perform steps described herein (e.g., steps described herein with reference to the flow charts). In other embodiments, NN 900 may be configured to perform steps described herein without the need for code. That is, for example, PC 902 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Additional Information

### 2.2.2 PRS Rx Frequency Hopping

The PRS repetition factor in PRS transmission for the positioning of normal NR UE can be configured to 1, 2, 4, 6, 8, 16, or 32, according to PRS Configuration IE in NRPPa 9.2.44, where the configurations of larger PRS repetition factors are used in use cases requesting deep coverage, such as the scenario of deep indoor UE with indoor or outdoor base stations and the scenario of outdoor base stations with larger coverage.

The use cases of RedCap UEs include wearable, industrial sensor, camera and so on, and thus these scenarios also are applicable to RedCap UEs. To get similar positioning accuracy as normal NR UE, one RedCap UE needs to measure narrowband PRS with multiple hops and longer time duration for accumulated wide bandwidth as normal NR UE. Therefore, the PRS repetition factor value range extension is expected for PRS-frequency-hopping-based RedCap positioning.

Observation 2: PRS transmission with longer time duration is preferred for PRS-frequency-hopping-based RedCap positioning.

To save downlink time-frequency resources, one TRP would prefer to enable PRS transmission with shorter time duration unless it is informed to support the feature of PRS frequency hopping. While, to get high positioning accuracy, the LMF may hope to obtain the measurement results based on longer PRS transmission for reliability improvement. To solve this preference mismatch, the LMF should know in advance if it is possible for gNB to configure even longer PRS repetition factor to support PRS Rx frequency hopping. Therefore, one specific indication of either RedCap positioning or extended PRS repetition factors in the On-demand PRS TRP Information IE and/or TRP Information IE in the TRP INFORMATION RESPONSE message can be helpful in this case.

Proposal 2: Indicate either RedCap positioning or extended PRS repetition factors in the On-demand PRS TRP Information and/or TRP Information in the TRP INFORMATION RESPONSE message.

The information of RedCap positioning can be a new IE in the TRP Information, or alternatively, adding new Allowed Extended Resource Repetition Factor Values IE in 9.2.65. The extension is a result of the legacy IE being limited to 8 codepoints, nd thus not possible to support more than one value for longer repetition factor.

| | | | |
|---|---|---|---|
| Allowed Extended | O | BIT | This IE applies only if the third bit |
| Resource Repetition | | STRING | of the On-demand PRS Request |
| Factor Values | | (SIZE(8)) | Allowed IE is set to ‘1’. |
| | | | Each position in the bitmap |
| | | | represents a value of the |
| | | | Resource Repetition Factor IE |
| | | | defined in subclause 9.2.61, first |
| | | | bit = rf1 and so on. Bit 10 is |
| | | | reserved for future use. Value ‘1’ |
| | | | indicates ‘request allowed’, Value |
| | | | ‘0’ indicates ‘request not |
| | | | allowed’. If this IE is absent, all |
| | | | Extended Resource Repetition |
| | | | Factor values are allowed to be |
| | | | requested. |

Proposal 3: Add a Allowed Extended Resource Repetition Factor Values IE in On-demand PRS TRP Information 9.2.65.

Once the LMF knows that TRP supports RedCap positioning or Extended Resource Repetition Factor Values, it can add a new codepoint to request TRPs to proceed with longer PRS repetition factor in PRS transmission for the use-case of RedCap positioning. This can be supported by LMF indicating the requested Resource Repetition Factor in the Requested DL PRS Transmission Characteristics IE within the PRS CONFIGURATION REQUEST message:

### 9.2.61 Requested DL PRS Transmission Characteristics

This IE contains the requested PRS configuration for transmission by the LMF.

| | | | IE Type and | |
|---|---|---|---|---|
| IE/Group Name | Presence | Range | Reference | Semantics Description |
| Requested DL-PRS | | 1 | | |
| Resource Set List | | | | |
| >Requested DL-PRS | | 1 . . . | | |
| Resource Set Item | | <maxnoofPRSresourceSet> | | |
| >>PRS bandwidth | O | | INTEGER(1 . . . 63) | 24, 28, . . . , 272 PRBs |
| >>Comb Size | O | | ENUMERATED(2, | |
| | | | 4, 6, 12, . . .) | |
| >>Resource Set | O | | ENUMERATED(4, 5, | |
| Periodicity | | | 8, 10, 16, 20, 32, 40, 64, | |
| | | | 80, 160, 320, 640, 1280, | |
| | | | 2560, 5120, 10240, | |
| | | | 20480, 40960, | |
| | | | 81920, . . .) | |
| >>Resource Repetition | O | | ENUMERATED(rf1, rf2, | |
| Factor | | | rf4, rf6, rf8, rf16, | |
| | | | rf32, . . . , rf64, rf128) | |
| >>Resource Number of | O | | ENUMERATED(n2, | |
| Symbols | | | n4, n6, n12, . . .) | |
| >>Requested DL-PRS | O | | 9.2.62 | |
| Resource List | | | | |
| >>Resource Set Start | O | | Start Time and | This IE is ignored if the Start |
| Time and Duration | | | Duration | Time and Duration IE is present |
| | | | 9.2.63 | |
| Number of Frequency | O | | INTEGER(1 . . . 4) | |
| Layers | | | | |
| Start Time and Duration | O | | 9.2.63 | |

The TRP, once configuring the PRS after receiving the LMF request, can feedback to LMF via the PRS CONFIGURATION REQUEST message of the configured repetition factor.

### 9.2.44 PRS Configuration

This information element contains the DL PRS configuration for the TRP.

| | | | IE Type and | |
|---|---|---|---|---|
| IE/Group Name | Presence | Range | Reference | Semantics Description |
| PRS Resource Set List | | 1 | | |
| >PRS Resource Set | | 1 . . . | | |
| Item | | <maxnoofPRSresourceSet> | | |
| >>PRS Resource Set | M | | INTEGER(0 . . . 7) | |
| ID | | | | |
| >>Subcarrier Spacing | M | | ENUMERATED(kHz | |
| | | | 15, kHz30, kHz60, | |
| | | | kHz120, . . .) | |
| >>PRS bandwidth | M | | INTEGER(1 . . . 63) | 24, 28, . . . , 272 PRBs |
| >>Start PRB | M | | INTEGER(0 . . . 2176) | Starting PRB to Point A |
| >>Point A | M | | INTEGER | NR ARFCN |
| | | | (0 . . . 3279165) | |
| >>Comb Size | M | | ENUMERATED(2, | |
| | | | 4, 6, 12, . . .) | |
| >>CP Type | M | | ENUMERATED(normal, | |
| | | | extended, . . .) | |
| >>Resource Set | M | | ENUMERATED(4, 5, | |
| Periodicity | | | 8, 10, 16, 20, 32, 40, 64, | |
| | | | 80, 160, 320, 640, 1280, | |
| | | | 2560, 5120, 10240, | |
| | | | 20480, 40960, | |
| | | | 81920, . . .) | |
| >>Resource Set Slot | M | | INTEGER(0 . . . | |
| Offset | | | 81919, . . .) | |
| >>Resource Repetition | M | | ENUMERATED(rf1, rf2, | values rf64, rf128are used for |
| Factor | | | rf4, rf6, rf8, rf16, | redcap freq hopping |
| | | | rf32, . . . , 64, 128) | |
| >>Resource Time Gap | M | | ENUMERATED(tg1, | |
| | | | tg2, tg4, tg8, tg16, | |
| | | | tg32, . . .) | |
| >>Resource Number of | M | | ENUMERATED(n2, | |
| Symbols | | | n4, n6, n12, . . .) | |
| >>PRS Muting | O | | | |
| >>>Option1 | O | | | |
| >>>>Muting Pattern | M | | DL-PRS Muting | Muting pattern option 1 is used to |
| | | | Pattern | mute the whole PRS resource |
| | | | 9.2.56 | set (within a period) |
| >>>>Muting Bit | M | | ENUMERATED(1, 2, | |
| Repetition Factor | | | 4, 8, . . .) | |
| >>>Option2 | O | | | |
| >>>>Muting Pattern | M | | DL-PRS Muting | Muting pattern option 2 is used to |
| | | | Pattern | mute the selected repetition of |
| | | | 9.2.56 | the resource set (within the |
| | | | | period) |
| >>PRS Resource | M | | INTEGER(−60 . . . 50) | |
| Transmit Power | | | | |
| >>PRS Resource List | | 1 | | Corresponds to information |
| | | | | provided in NR-DL-PRS- |
| | | | | Resource contained in NR-DL- |
| | | | | PRS-Info IE as defined in TS |
| | | | | 37.355[14] |
| >>>PRS Resource | | 1 . . . | | |
| Item | | <maxnoofPRSresources> | | |
| >>>>PRS Resource | M | | INTEGER(0 . . . 63) | |
| ID | | | | |
| >>>>Sequence ID | M | | INTEGER(0 . . . 4095) | |
| >>>>RE Offset | M | | INTEGER(0 . . . 11, . . .) | |
| >>>>Resource Slot | M | | INTEGER(0 . . . 511) | |
| Offset | | | | |
| >>>>Resource | M | | INTEGER(0 . . . 12) | |
| Symbol Offset | | | | |
| >>>>CHOICE QCL | O | | | |
| Info | | | | |
| >>>>>SSB | | | | |
| >>>>>>NR PCI | M | | INTEGER(0 . . . 1007) | |
| >>>>>>SSB | O | | INTEGER(0 . . . 63) | |
| Index | | | | |
| >>>>>DL-PRS | | | | |
| >>>>>>QCL | M | | INTEGER(0 . . . 7) | |
| Source PRS | | | | |
| Resource Set ID | | | | |
| >>>>>>QCL | O | | INTEGER(0 . . . 63) | If it is absent, the QCL source |
| Source PRS | | | | PRS resource ID is the same as |
| Resource ID | | | | the PRS resource ID |

| Range bound | Explanation |
|---|---|
| maxnoofPRSresourceSet | Maximum no of PRS resources set. Value is 8. |
| maxnoofPRSresource | Maximum no of PRS resources per PRS resource set. Value is 64. |

Note: other parameters such as Resource Time Gap may also need to be impacted of RedCap UE PRS frequency hopping.

Proposal 4: Extend the Resource Time Gap IE in Requested DL PRS Transmission Characteristics and PRS Configuration with new values 64 and 128 for RedCap PRS frequency hopping. FFS if other parameters such as Resource Time Gap are also impacted.

1. A method performed by a first network node, the method comprising:
receiving, from a second network node, a configuration request message for on-demand positioning reference signal (PRS) configuration with at least a first transmission and reception point (TRP) associated with the first network node, wherein the configuration request message comprises an extended PRS repetition factor value for the first TRP; and
after receiving the request message, transmitting to the second network node a response message responsive to the request message, indicating that on-demand PRS configuration is configured or updated with at least the first TRP.

2. The method of claim 1, wherein the response message comprises:
an extended PRS repetition factor value being configured or updated with the first TRP.

3. The method of claim 1, wherein
the PRS is a downlink reference signal for positioning, or
the PRS is an uplink reference signal for positioning.

4. The method of claim 1, wherein the on-demand PRS configuration with the first TRP is associated with a specific type of user equipment.

5. A non-transitory computer readable storage medium storing a computer program comprising instructions for configuring the first network node to perform the method of claim 1.

6. A method performed by a first network node, the method comprising:
transmitting to a second network node a configuration request message for on-demand positioning reference signal (PRS) configuration with at least a first transmission and reception point (TRP) associated with the first network node, wherein the configuration request message comprises an extended PRS repetition factor value for the first TRP; and
after transmitting the configuration request message, receiving from the second network node a response message responsive to the request message, indicating that on-demand PRS configuration is configured or updated with at least the first TRP.

7. The method of claim 6, wherein the response message comprises:
an extended PRS repetition factor value being configured or updated with the first TRP.

8. The method of claim 6, wherein
the PRS is a downlink reference signal for positioning, or
the PRS is an uplink reference signal for positioning.

9. The method of claim 6, wherein the on-demand PRS configuration with the first TRP is associated with a specific type of user equipment.

10. A non-transitory computer readable storage medium storing a computer program comprising instructions for configuring the first network node to perform the method of claim 6.

11. A first network node, the first network node comprising:
memory; and
processing circuitry, wherein the first network node is configured to perform a method comprising:
receiving, from a second network node, a configuration request message for on-demand positioning reference signal (PRS) configuration with at least a first transmission and reception point (TRP) associated with the first network node, wherein the configuration request message comprises an extended PRS repetition factor value for the first TRP; and
after receiving the request message, transmitting to the second network node a response message responsive to the request message, indicating that on-demand PRS configuration is configured or updated with at least the first TRP.

12. The first network node of claim 11, wherein the response message comprises:
an extended PRS repetition factor value being configured or updated with the first TRP.

13. The first network node of claim 11, wherein
the PRS is a downlink reference signal for positioning, or
the PRS is an uplink reference signal for positioning.

14. The first network node of claim 11, wherein the on-demand PRS configuration with the first TRP is associated with a specific type of user equipment.

15. A first network node, the first network node comprising:
memory; and
processing circuitry, wherein the first network node is configured to perform a method comprising:
transmitting to a second network node, a configuration request message for on-demand positioning reference signal (PRS) configuration with at least a first transmission and reception point (TRP) associated with the first network node, wherein the configuration request message comprises an extended PRS repetition factor value for the first TRP; and
after transmitting the configuration request message, receiving from the second network node a response message responsive to the request message, indicating that on-demand PRS configuration is configured or updated with at least the first TRP.

16. The first network node of claim 15, wherein the response message comprises:
an extended PRS repetition factor value being configured or updated with the first TRP.

17. The first network node of claim 15, wherein
the PRS is a downlink reference signal for positioning, or
the PRS is an uplink reference signal for positioning.

18. The first network node of claim 15, wherein the on-demand PRS configuration with the first TRP is associated with a specific type of user equipment.
